(19) United States
(12) Patent Application Publication
(10) Pub. No.: US 2007/0217969 A1
(43) Pub. Date: Sep. 20, 2007

(54) Hydroxy radical generator

(76) Inventor: Chun-Cheng Cheng, Taipei Hsien (TW)

Correspondence Address: POSZ LAW GROUP, PLC, 12040 SOUTH LAKES DRIVE, SUITE 101, RESTON, VA, 20191, US

(21) Appl. No.: 11/373,969

(22) Filed: Mar. 14, 2006

(51) Int. Cl. B01J 19/12

(52) U.S. Cl. 422/186.3

(57) ABSTRACT

A hydroxy (OH) radical generator has a shade assembly and an ultraviolet (UV) generator. The shade assembly has two end caps and multiple shades mounted between the end caps, arranged in a concentric configuration wherein one shade covers another. Each shade has a surface, two end edges, a set of multiple vents defined through the shade and a photo-catalyzer coating attached to the surface of the shade. The sets of the vents in adjacent shades are staggered and are misaligned with each other. The UV generator is mounted in the shade assembly and generates UV when operating. The shade assembly with the staggered sets of the vents effectively prevents the UV from leaking out to harm people when the OH radical generator operates. Therefore, the operating OH radical generator is safe and exactly benefits human body without any side effects.

### BACKGROUND OF THE INVENTION

1. Field of the Invention

The present invention relates to a generator, and more particularly to a hydroxy radical generator that prevents ultraviolet radiated by the generator from leaking out excessively.

2. Description of Related Art

People stay indoors for a long time everyday. The indoor air quality effectively influences human healthy. Articles with organic compounds such as formaldehyde, benzene and ammonia, mold, germs and smells of paint, shoes and carpet in the air deteriorate the air quality and make people staying indoors feel uncomfortable.

Therefore, hydroxy (OH) radical generators have been developed to purify the indoor air and improve human healthy. A conventional OH radical generator has an ultraviolet (UV) generator and a shade. The shade is coated with a photo-catalyzer coating made of titanium dioxide (TiO₂) and covers partially the UV generator. When the OH radical generator operates, the TiO₂ absorbs UV radiated from the UV generator and reacts with hydrogen oxide (H₂O) in the air to generate hydroxyl radicals to decompose germs and mold and deodorize articles such as shoes, clothes and furniture.

However, partial UV from the UV generator passes through the shade and is radiated on nearby people to make them feel uncomfortable and even get skin disease.

To overcome the shortcomings, the present invention provides a hydroxy radical generator to mitigate or obviate the aforementioned problems.

### SUMMARY OF THE INVENTION

The main objective of the invention is to provide a hydroxy (OH) radical generator that prevents ultraviolet radiated by the generator from leaking out excessively.

A hydroxy (OH) radical generator in accordance with the present invention comprises a shade assembly and an ultraviolet (UV) generator.

The shade assembly has two end caps and a set of multiple shades mounted between the end caps, arranged in a concentric configuration wherein one shade covers another. Each shade has a surface, two end edges, a set of multiple vents defined through the shade and a photo-catalyzer coating attached to the surface of the shade. The sets of the vents in adjacent shades are staggered and are misaligned with each other.

The UV generator is mounted in the shade assembly, generates UV when operating.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a hydroxy (OH) radical generator in accordance with the present invention;

FIG. 2 is an exploded perspective view of the OH radical generator in FIG. 1;

FIG. 3 is a cross sectional end view of the OH radical generator in FIG. 1;

FIG. 3A is an enlarged cross sectional end view of the shade of the OH radical generator in FIG. 3 coated with the photo-catalyzer coating;

FIG. 4 is a perspective view of a second embodiment of an OH radical generator in accordance with the present invention;

FIG. 5 is an exploded perspective view of the OH radical generator in FIG. 4;

FIG. 6 is a cross section end view of the OH radical generator in FIG. 4;

FIG. 7 is an exploded perspective view of a shade assembly of a third embodiment of the OH radical generator in accordance with the present invention;

FIG. 8 is an exploded perspective view of a shade assembly of a fourth embodiment of the OH radical generator in accordance with the present invention; and

FIG. 9 is an exploded perspective view of a shade assembly of a fifth embodiment of the OH radical generator in accordance with the preset invention.

### DETAILED DESCRIPTION OF THE PREFERRED EMBODIMENT

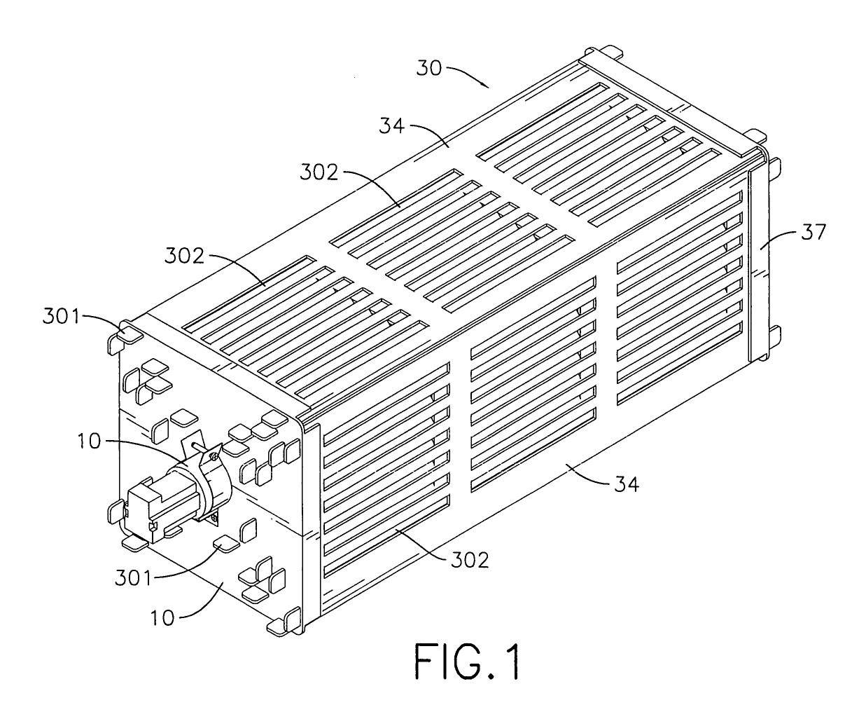

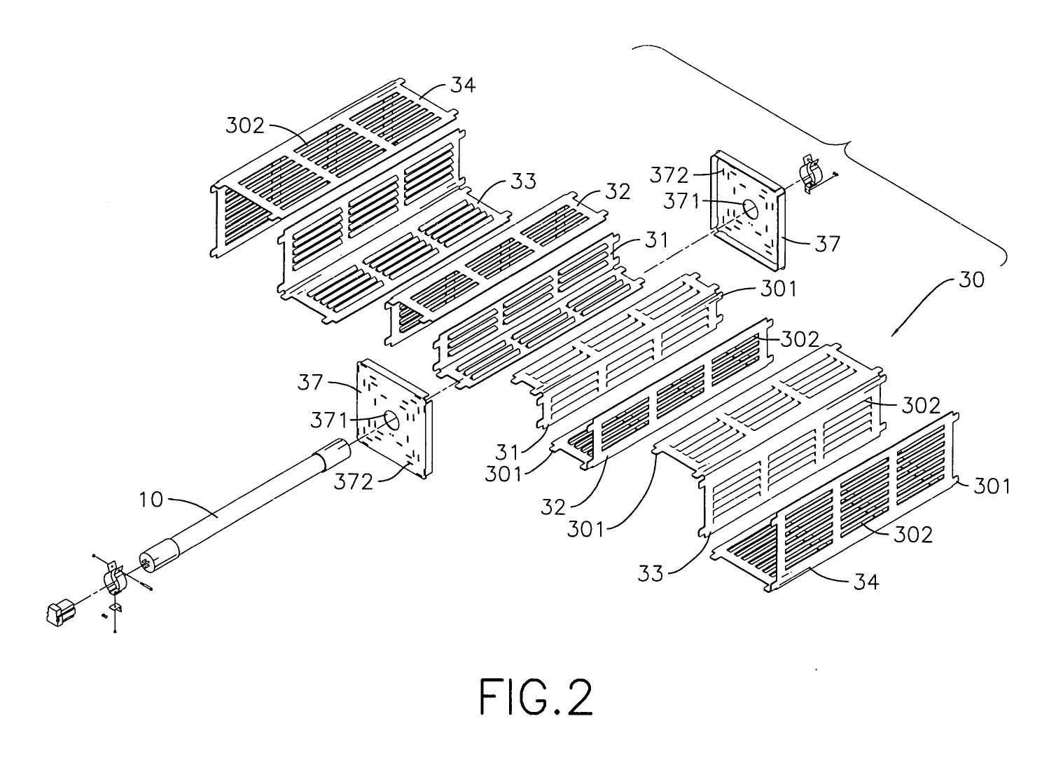

With reference to FIGS. 1 and 2, a first embodiment of a hydroxy (OH) radical generator in accordance with the present invention comprises a shade assembly (30) and an ultraviolet (UV) generator (10).

The shade assembly (30) has two end caps (37) and a set of multiple shades.

Each end cap (37) has a mounting hole (371) and multiple mounting slots (372) defined through the cap (37).

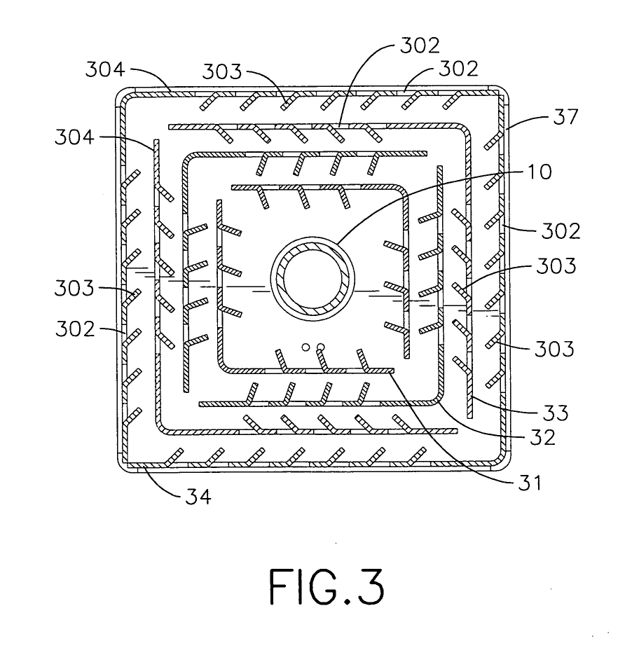

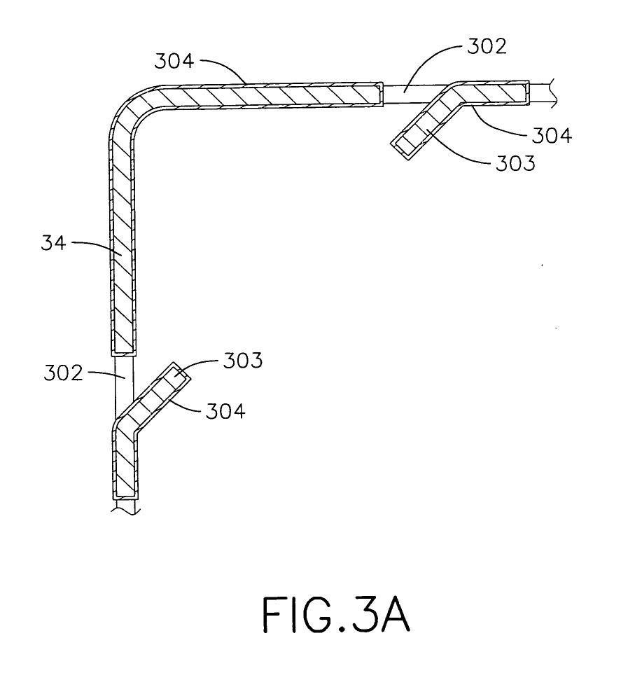

With further reference to FIG. 3, the shades are mounted between the end caps (37), are arranged in a concentric configuration wherein one shade covers another. Each shade is rectangular, may comprise two L-shaped shade halves (31, 32, 33, 34) and has a surface, two end edges, multiple mounting tabs (301), a set of multiple vents (302), multiple reflecting tabs (303) and a photo-catalyzer coating (304).

The mounting tabs (301) extend out from the end edges of the shade and are mounted respectively through the mounting slots (372) in the end caps (37).

The vents (302) of the set are longitudinal and are defined through the shade and allow inside air containing OH radicals to pass through the vents (302) out of the shade assembly (30). Each vent (302) has an inner edge (302). The sets of the vents (302) in adjacent shades are staggered and are misaligned with each other so that the UV is filtered partially off and weakens whenever passing through the vents of a shade. Therefore, the UV in the shade assembly (30) is hardly radiated out of the shade assembly (30) to harm people.

The reflecting tabs (303) respectively extend out and are inclined from the inner edge of the vents (302) and reflect UV from a center of the shade assembly (30) back to prevent the UV from leaking out of the shade assembly (30).

With further reference to FIG. 3A, the photo-catalyzer coating (304) is attached to the surface of the shade, is made of titanium dioxide (TiO₂), may absorb the UV and react with hydrogen oxide (H₂O) in the air to generate OH radicals to decompose germs and mold and deodorize articles such as shoes, clothes and furniture.

The UV generator (10) is mounted in the shade assembly (30), generates UV when operating and has two ends respectively mounted through the mounting holes (371) in the end caps (37).

The UV from the operating UV generator (10) is radiated on the photo-catalyzer coatings (304) on the shades and reacts with the TiO₂ to generate OH radicals for decomposition of germs and mold and deodorization of smells. Furthermore, the shade assembly (30) with the concentric configuration and staggered arrangement of vents (302) between adjacent shades prevents the UV from leaking out of the shade assembly (30).

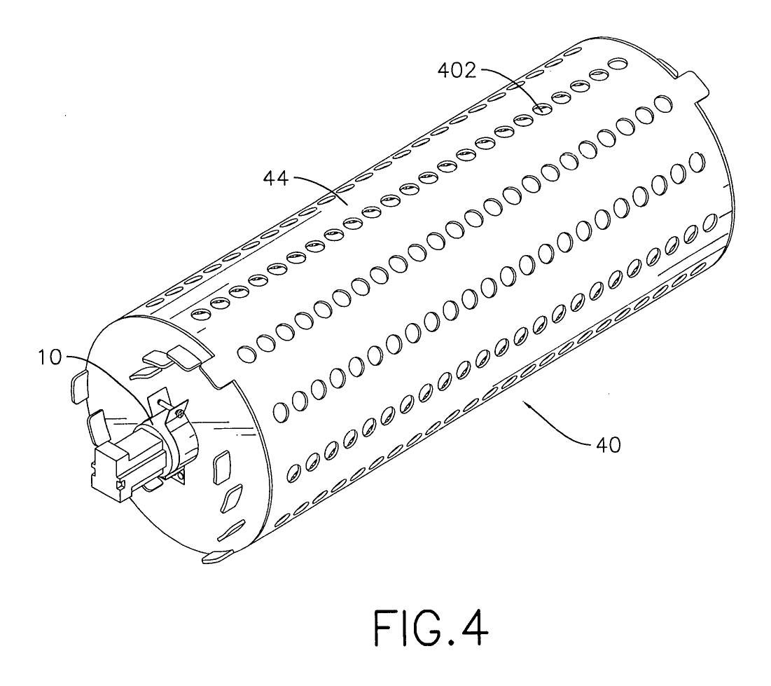

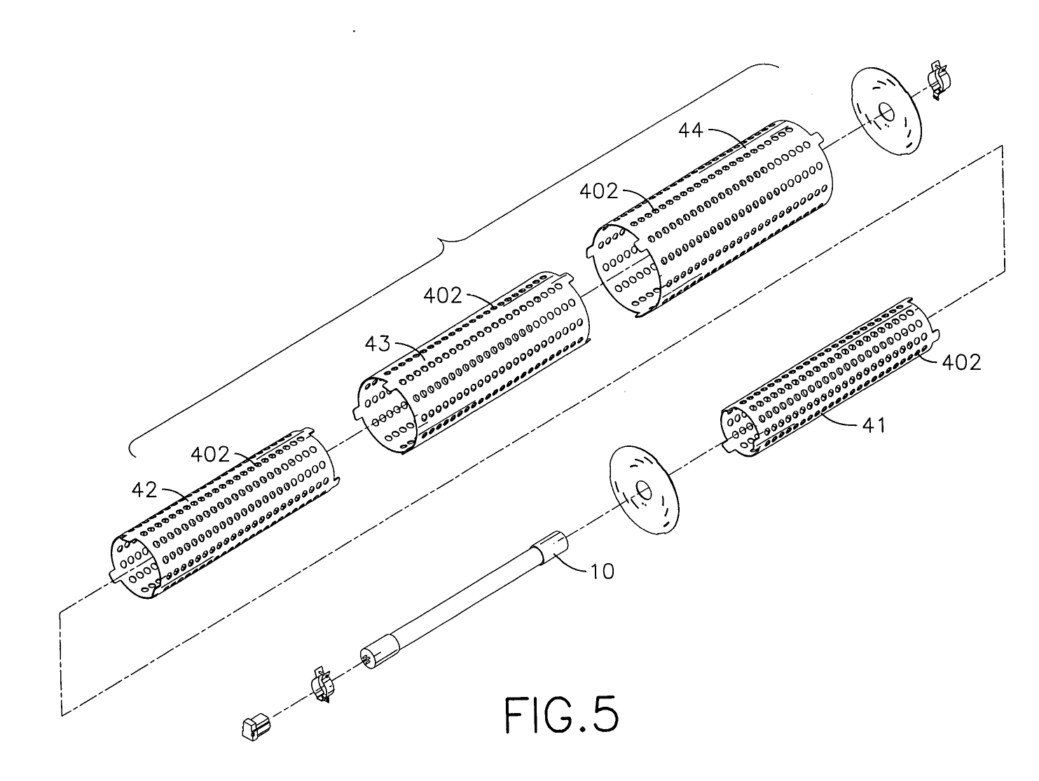

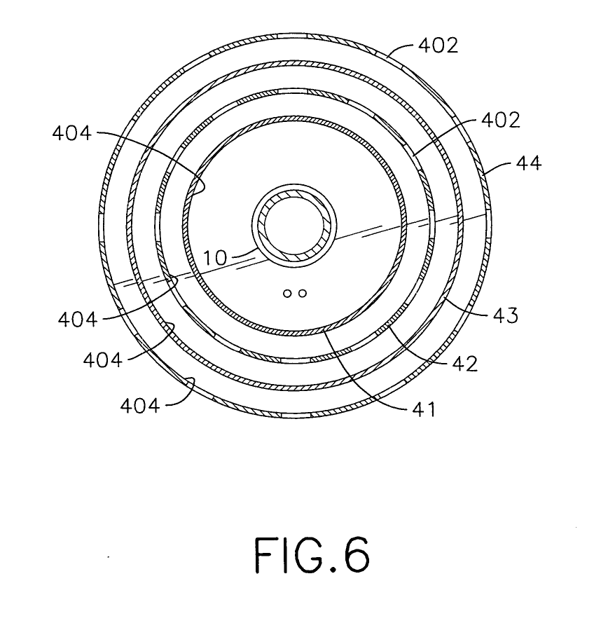

With reference to FIGS. 4-6, a second embodiment of the OH radical generator in accordance with the present invention is similar to the first embodiment and has the shade assembly (40) differing from that in the first embodiment.

The shade assembly (40) has a set of multiple shades (41, 42, 43, 44) arranged in a concentric configuration wherein one shade (42, 43, 44) covers another. Each shade (41, 42, 43, 44) is cylindrical, is coated with a photo-catalyzer coating (404) and has a set of multiple vents (402). The vents (402) are circular and defined through the shade (41, 42, 43, 44). The sets of the vents (402) in adjacent shades (41, 42, 43, 44) are staggered and are misaligned with each other so that the UV in the shade assembly (40) hardly escapes out of the shade assembly (30).

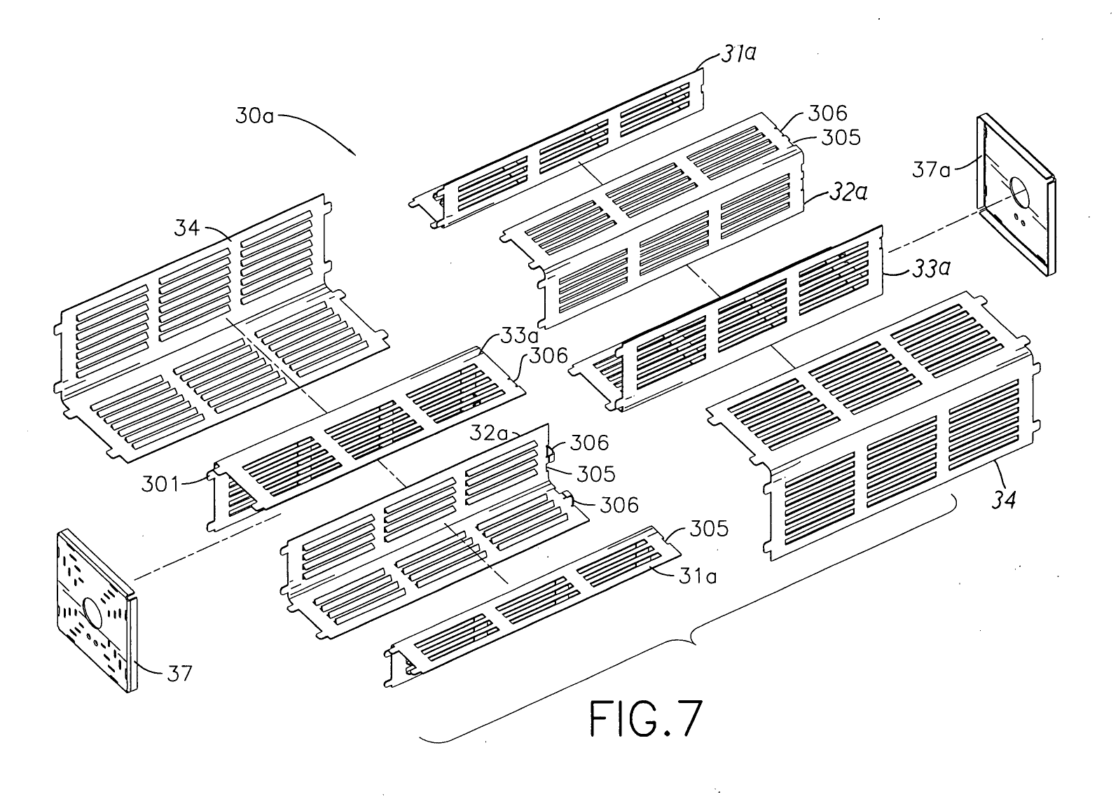

With reference to FIG. 7, a third embodiment of the OH radical generator in accordance with the present invention is similar to the first embodiment and has the shade assembly (30a) differing from that of the first embodiment.

The shade assembly (30a) has two end caps (37, 37a) and a set of multiple shades arranged in a concentric configuration wherein one shade covers another. The set of the shades has an inside shade, an outside shade and multiple intervening shades.

The inside shade may comprise two shade halves (31a) and has two end edges, multiple mounting tabs (301) as those described in first embodiment and multiple mounting notches (305). The mounting tabs (301) extend out from one end edge and are mounted through corresponding mounting slots (372) in one end cap (37). The mounting notches (305) are defined in the other end edge.

The outside shade, as the shade described in the first embodiment and may comprise two shade halves (34).

The intervening shades are located between the inside and outside shades and each intervening shade may comprise two shade halves (31a, 32a). An innermost one of the intervening shades has multiple mounting hooks (306) formed on one end edge and respectively hooking the mounting notches (306) in the inside shade. Any adjacent two of the intervening shades are mounted to each other with a fastener. The fastener has multiple mounting notches (305) and multiple hooks (306). The mounting notches (305) are defined in one end edge of an inner intervening shade of the adjacent two. The mounting hooks (306) are formed on one edge of an outer intervening shade of the adjacent two and respectively hook the mounting notches (305) in the inner intervening shade of the adjacent two.

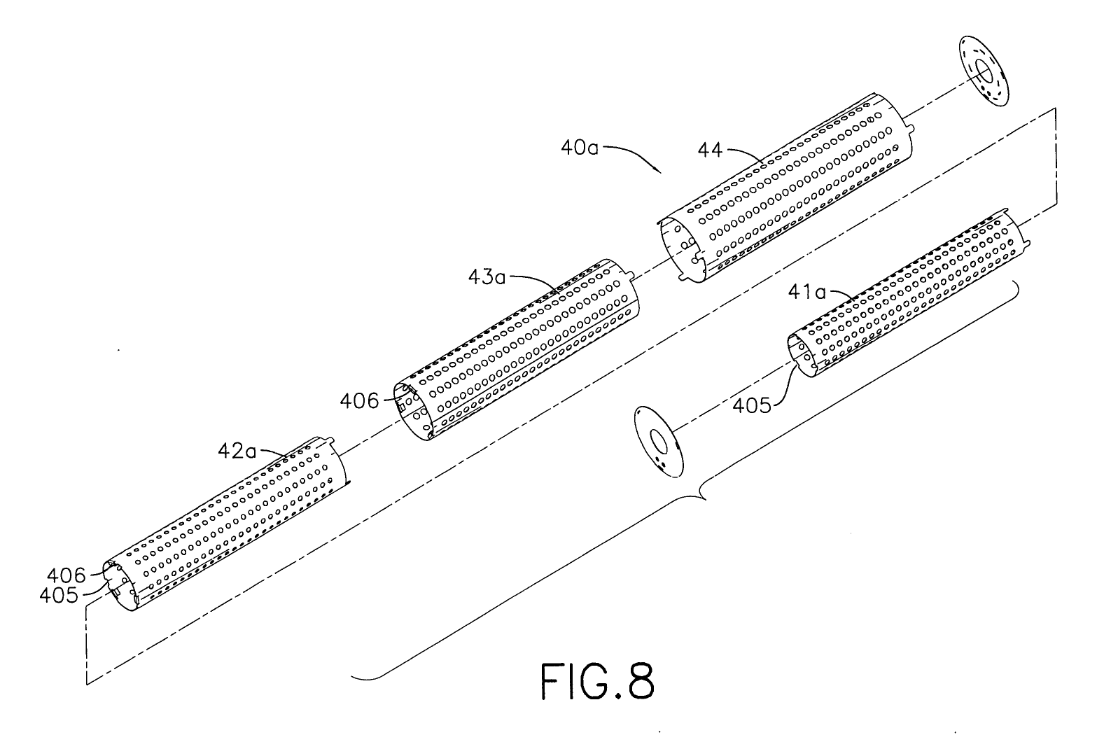

With reference to FIG. 8, a fourth embodiment of the OH radical generator in accordance with the present invention is similar to the second embodiment and has the shade assembly (40a) differing from that of the second embodiment.

The shade assembly (40a) has two end caps (37, 37a) and a set of multiple shades (41a, 42a, 43a, 44) arranged in a concentric configuration wherein one shade (42a, 43a, 44) covers another. The set of the shades (41a, 42a, 43a, 44) has an inside shade (41a), an outside shade (44) and multiple intervening shades (42a, 43a) as similar to those described in the third embodiment.

The inside shade (41a) has multiple mounting notches (405).

The outside shade (44) are similar to the shade (44) described in the second embodiment.

Each of the intervening shades (42, 43a) has multiple mounting hooks (406) as those described in the third embodiment. An inner shade (43a) of any adjacent two of the intervening shades (42, 43a) has multiple mounting notches (405) corresponding to the mounting hooks (406).

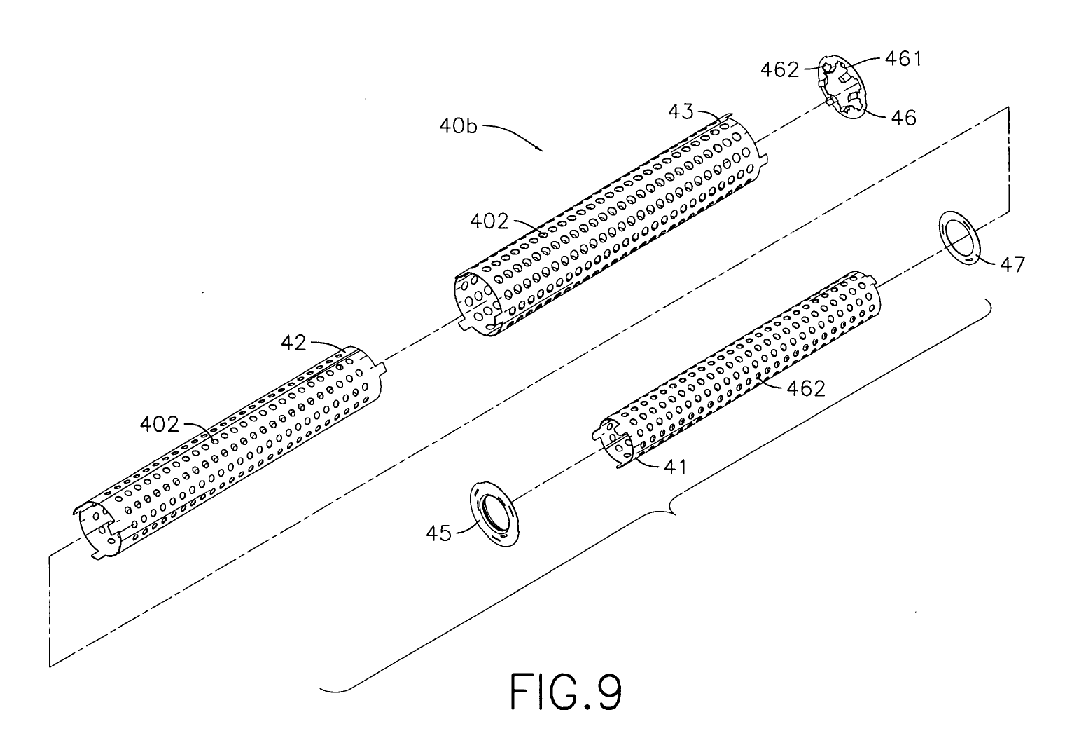

With reference FIG. 9, a fifth embodiment of the OH radical generator in accordance with the present invention is similar to the second embodiment and has the shade assembly (40b) differing from that of the second embodiment and having a set of multiple shades (41,42,43), two end caps (45, 46) and a retaining collar (47). One end cap (46) is annular and has an inner edge, multiple recesses (461) and multiple retaining tabs (462). The recesses (461) are defined in the inner edge and receive respectively the mounting tabs on one end edge of an outermost shade (43) of the set. The retaining tabs (462) extend from the inner edge, are curved outward and press against an inner surface of the outermost shade (43). The retaining collar (47) is mounted to an inner shade (42) of the set and has multiple mounting slots (47) respectively receiving the mounting tabs on one end of the inner shade (42).

The shade assembly (30, 40) with the staggered sets of the vents (402) effectively prevents the UV from leaking out to harm people when the OH radical generator operates. Therefore, the operating OH radical generator is safe and exactly benefits human body without any side effects.

What is claimed is:

1. A hydroxy (OH) radical generator comprising:
a shade assembly having
two end caps; and
a set of multiple shades mounted between the end caps, arranged in a concentric configuration wherein one shade covers another and each shade having a surface, two end edges, a set of multiple vents defined through the shade and a photo-catalyzer coating attached to the surface of the shade and the sets of the vents in adjacent shades staggered and misaligned with each other; and
an ultraviolet (UV) generator mounted in the shade assembly, generating UV when operating and having two ends respectively mounted to the end caps.

2. The OH radical generator as claimed in claim 1, wherein each vent has an inner edge and the each shade further has multiple reflecting tabs respectively extending out and inclined from the inner edge of the vents of each shade.

3. The OH radical generator as claimed in claim 2, wherein each shade comprises two shade halves and the vents in the shades are longitudinal.

4. The OH radical generator as claimed in claim 1, wherein each shade is cylindrical and the vents in the shades are circular.

5. The OH radical generator as claimed in claim 1, wherein each end cap has multiple mounting slots defined through the end cap and each shade further has multiple mounting tabs extending out from the end edges of the shade and respectively mounted through the mounting slots in the end caps.

6. The OH radical generator as claimed in claim 2, wherein each end cap has multiple mounting slots defined through the end cap and each shade further has multiple mounting tabs extending out from the end edges and respectively mounted through the mounting slots in the end caps.

7. The OH radical generator as claimed in claim 2, wherein the photo-catalyzer is made of titanium dioxide.

8. The OH radical generator as claimed in claim 1, wherein:
each end cap has multiple mounting slots defined through the end cap;
the set of shades has
an inside shade having two end edges, multiple mounting tabs extending out from one end edge and respectively mounted through in corresponding mounting slots in one of the end caps and multiple mounting notches defined in the other end edge;
an outside shade having two end edges and multiple mounting tabs respectively mounted through corresponding mounting tabs in the end caps; and
multiple intervening shades located between the inside and outside shades and an innermost one of the intervening shades having multiple mounting hooks formed on one end edge and respectively hooking the mounting notches in the inside shade, wherein any adjacent two of the intervening shades are mounted to each other with a fastener having
multiple mounting notches defined in one end edge of an inner intervening shade of the adjacent two intervening shades; and
multiple mounting hooks formed on one edge of an outer intervening shade of the adjacent two intervening shades and respectively hooking the mounting notches in the inner intervening shade.
